(19) United States
(12) Patent Application Publication
(10) Pub. No.: US 2025/0103802 A1
(43) Pub. Date: Mar. 27, 2025

(54) METHOD AND APPARATUS FOR OPTIMIZING CONTENT GENERATED BY LARGE MODEL, ELECTRONIC DEVICE AND STORAGE MEDIUM

(71) Applicant: BEIJING BAIDU NETCOM SCIENCE TECHNOLOGY CO., LTD., Beijing (CN)

(72) Inventor: Guangyuan Yan, Beijing (CN)

(73) Assignee: BEIJING BAIDU NETCOM SCIENCE TECHNOLOGY CO., LTD., Beijing (CN)

(21) Appl. No.: 18/974,408

(22) Filed: Dec. 9, 2024

(30) Foreign Application Priority Data
Sep. 19, 2024 (CN) 202411311016.4

(51) Int. Cl. G06F 40/20

(52) U.S. Cl. CPC G06F 40/20

(57) ABSTRACT

The disclosure provides a method for optimizing content generated by a large model, an apparatus for optimizing content generated by a large model, an electronic device and a storage medium, and relates to the technical field of artificial intelligence, especially to the technical fields of text processing, large language model and the like. It can be applied to official document processing, automatic contract generation, legal document writing, enterprise internal system management and so on. The method includes: obtaining a question entered by a user, wherein the question is used to instruct a generation of a text of a target type; obtaining a set of target rules corresponding to the target type from a plurality of preset sets of rules, in which the set of target rules includes a plurality of target rules, and the target rules are rules followed by the target type of text; and according to a sequence of the target rules, inputting the plurality of target rules into a large language model sequentially to obtain a target text of the target type generated by the large language model. In this way, the accuracy of generating text following certain rules by the large language model is improved.

### CROSS REFERENCE TO RELATED APPLICATIONS

This application claims priority and benefits to Chinese Application No. 202411311016.4, filed on Sep. 19, 2024, the entire content of which is incorporated herein by reference.

### TECHNICAL FIELD

The disclosure relates to the technical field of artificial intelligence, in particular to the technical fields of text processing and large language model.

### BACKGROUND

With the wide application of artificial intelligence technologies, Large Language Model (LLM) has shown great potential in content generation due to its powerful natural language understanding and generation capability. For example, currently, the LLM can be widely used in knowledge answering, content creation, intelligent customer service, code development and information extraction.

### SUMMARY

The disclosure provides a method for optimizing content generated by a large model, an apparatus for optimizing content generated by a large model, an electronic device and a storage medium.

According to a first aspect of embodiments of the disclosure, a method for optimizing content generated by a large model is provided. The method includes:
obtaining a question entered by a user, in which the question is used to instruct a generation of a text of a target type;
obtaining, from a plurality of preset sets of rules, a set of target rules corresponding to the target type, wherein the set of target rules comprises a plurality of target rules, and the target rules are rules to be followed by the text of the target type; and
inputting the plurality of target rules sequentially into a large language model according to a sequence of the plurality of target rules to obtain a target text of the target type generated by the large language model.

According to a second aspect of embodiments of the disclosure, an apparatus for optimizing content generated by a large model is provided. The apparatus includes:
an obtaining module, configured to obtain a question entered by a user, in which the question is used to instruct a generation of a text of a target type;
the obtaining module, further configured to obtain a set of target rules corresponding to the target type from a plurality of preset sets of rules, in which the set of target rules includes a plurality of target rules, and the target rules are rules followed by the target type of text; and
a generating module, configured to, according to a sequence of the target rules, input the target rules into a large language model sequentially to obtain a target text of the target type generated by the large language model.

According to a third aspect of embodiments of the disclosure, an electronic device is provided. The electronic device includes:
at least one processor; and
a memory communicatively connected to the at least one processor;
in which the memory stores instructions executable by the at least one processor, and the instructions are executed by the at least one processor to cause the at least one processor to implement the method of the first aspect.

According to a fourth aspect of embodiments of the disclosure, a non-transitory computer-readable storage medium having computer instructions stored thereon is provided. The computer instructions are used to cause a computer to implement the method of the first aspect.

According to a fifth aspect of embodiments of the disclosure, a computer program product including a computer program is provided. When the computer program is executed by a processor, the method of the first aspect is implemented.

It should be understood that the content described in this section is not intended to identify key or important features of the embodiments of the disclosure, nor is it intended to limit the scope of the disclosure. Additional features of the disclosure will be easily understood from the following description.

### BRIEF DESCRIPTION OF THE DRAWINGS

The accompanying drawings are used to better understand this solution and do not constitute a limitation to the disclosure, in which:

FIG. 1 is a flowchart of a method for optimizing content generated by a large model provided by an embodiment of the disclosure.

FIG. 2 is a flowchart of a method for generating a target text provided by an embodiment of the disclosure.

FIG. 3 is a flowchart of a method for processing a parallel node provided by an embodiment of the disclosure.

FIG. 4 is a flowchart of a method for processing a cyclic node provided by an embodiment of the disclosure.

FIG. 5 is a flowchart of a method for processing a judgment node provided by an embodiment of the disclosure.

FIG. 6 is a flowchart of a method for verifying a target text provided by an embodiment of the disclosure.

FIG. 7 is an exemplary schematic diagram of a set of target rules provided by an embodiment of the disclosure.

FIG. 8 is a schematic diagram of an apparatus for optimizing content generated by a large model provided by an embodiment of the disclosure.

FIG. 9 is a block diagram of an electronic device used to realize the method for optimizing content generated by a large model provided by an embodiment of the disclosure.

### DETAILED DESCRIPTION

The following description of exemplary embodiments of the disclosure is provided in combination with the accompanying drawings, which includes various details of the embodiments of the disclosure to aid in understanding, and should be considered merely exemplary. Those skilled in the art understood that various changes and modifications of the embodiments described herein can be made without departing from the scope and spirit of the disclosure. For the sake of clarity and brevity, descriptions of well-known functions and structures are omitted from the following description.

Large language model (LLM) is obtained by training a deep learning model using massive data, and the accuracy of its output results mainly depends on the data used in the training. However, when generating contents, LLM often lacks the cognitive capability of rules that need to be followed in a specific scenario, resulting in generated content does not meet the actual needs of the specific scenario, which greatly limits the application of the LLM in fields or products that need to strictly comply with specific standards or specifications.

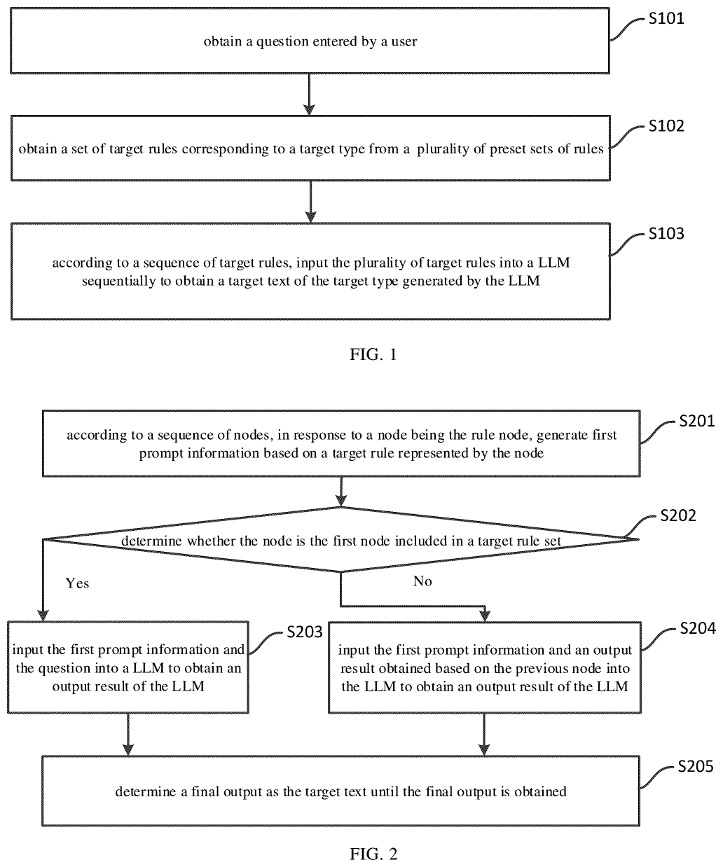

To solve this problem, the embodiment of the disclosure provides a method for optimizing content generated by a large model. The method is applied to an electronic device, such as a server or a desktop computer with data processing capabilities or the like. As illustrated in FIG. 1, the method includes the following steps.

At step S101, a question entered by a user is obtained.

In the embodiment of the display disclosure, the terminal may display an input interface, and the user may enter a question within the input interface by means of keyboard input or voice input. Then, when the terminal detects that the user has triggered a submit command, it sends the question entered by the user to the electronic device.

Alternatively, the electronic device may display an input interface, and the user may enter a question within the input interface by means of keyboard input or voice input.

The question is used to instruct the generation of a text of a target type. For example, the target type may be enterprise regulation, contract, official document or patent document.

For example, if the question entered by the user is: “help me generate an employment contract between Company A and employee B”, the target type is contract.

At step S102, a set of target rules corresponding to the target type is obtained from a plurality of preset sets of rules.

Each set of rules includes a plurality of rules followed by one type of text. Correspondingly, the set of target rules includes a plurality of target rules, and the target rules are rules followed by the target type of text.

For example, if the target type is contract, the set of target rules may include: having Party A's signature or seal, having Party B's signature or seal, and capitalizing the first letter of English when Party A's name or Party B's name includes English letters.

At step S103, according to the sequence of the plurality of target rules, the plurality of target rules are sequentially input into a LLM to obtain a target text of the target type generated by the LLM.

By the method shown in FIG. 1, the embodiment of the disclosure can obtain the set of target rules corresponding to a target type to which the text to be generated by the user belongs from a plurality of preset sets of rules. According to the sequence of the plurality of target rules included in the set of target rules, the plurality of target rules are sequentially input into the LLM to obtain the target text of the target type generated by the LLM. In the embodiment of the disclosure, the rules that the target type of text needs to follow are sequentially input into the LLM, the LLM can constrain its own generated content based on the target rules during the process of generating the content, which improves the accuracy of the target text generated by the LLM following the target rules.

The method for optimizing content generated by a large model provided by the embodiment of the disclosure will be described in detail below.

In step S102, the electronic device obtains the set of target rules corresponding to the target type from the plurality of preset sets of rules in the following two ways.

In the first way, from the plurality of preset sets of rules, the set of rules selected by the user, is used as the set of target rules.

The input interface of the terminal may display controls and introduction information of the plurality of sets of rules, in which the introduction information is used to indicate a type corresponding to a set of rules. The terminal may receive the control selected by the user within the input interface and send an identifier (ID) of the set of rules corresponding to the control to the electronic device. The electronic device determines the set of rules selected by the user based on the received ID of the set of rules and uses this set of rules as the set of target rules.

Alternatively, the input interface of the electronic device may display controls and introduction information of the plurality of sets of rules. The electronic device may receive the control selected by the user within the input interface, and uses the set of rules corresponding to the control selected by the user as the set of target rules.

In the second way, text classification of the question is performed to obtain the target type to which a generated text instructed by the question belongs, and the set of target rules corresponding to the target type is obtained based on the correspondence between the plurality of preset sets of rules and the preset types.

The electronic device may feed the question into a classifier to perform text classification of the question through the classifier, so as to obtain the target type output by the classifier. Then, based on the correspondence between the pre-stored plurality of sets of rules and the preset types, the set of target rules corresponding to the target type is obtained.

For example, the classifier may be a Long Short-Term Memory (LSTM), a Naive Bayesian model or a Support Vector Machine (SVM).

For example, the correspondence between the plurality of set of rules and the preset types is shown in Table 1.

TABLE 1

| set of rules | Type |
|---|---|
| set of rules 1 | Contract |
| set of rules 2 | Enterprise regulation |
| set of rules 3 | Patent document |

If the target type is Contract, the set of target rules is set of rules 1.

By the above method, the embodiment of the disclosure support user to select a set of rules, and also support obtaining a set of target rules corresponding to a target type by analyzing the target type to which the question entered by the user belongs. That is, both manual and automatic selection of the set of target rules are supported in the embodiment of the disclosure, which improves the flexibility and makes the application scope of the embodiment of the disclosure wider.

In some embodiments of the disclosure, the set of target rules in FIG. 1 includes a plurality of nodes connected in series. The plurality of nodes include a rule node representing a target rule.

On the basis, as illustrated in FIG. 2, in step S103, according to the sequence of target rules, inputting sequentially the target rules into the LLM to obtain the target text of the target type generated by the LLM includes the following steps.

At step S201, according to a sequence of nodes, in response to a node being the rule node, first prompt information is generated based on a target rule represented by the node.

In an implementation, the electronic device may obtain a preset prompt template, and then fills the target rule represented by the rule node into the prompt template to obtain the first prompt information.

For example, the prompt template is: “Rule: xxxxx; generate text that follows the above rules”, in which “xxxxx” serves as a placeholder. If the target rule is “the name of the enterprise is Party A and the name of the person is Party B”, the first prompt information obtained after filling the target rule into the prompt template is “Rule: the name of the enterprise is Party A and the name of the person is Party B, generate text that follows the above rules”.

In another implementation, the electronic device inputs the target rule represented by the rule node into a Natural Language Processing (NLP) model and obtains the first prompt information output by the NLP model. For example, NLP model may be a Transformer, a Bidirectional Encoder Representations from Transformers (BERT) or a LLM.

Alternatively, the electronic device generates the first prompt information based on the target rule in other ways, which is not specifically limited in the embodiment of the disclosure.

At step S202, it is determined whether the node is the first node included in the set of target rules, if so, S203 is performed, if not, S204 is performed.

At step S203, the first prompt information and the question are input into a LLM to obtain an output result of the LLM.

At step S204, the first prompt information and an output result obtained based on the previous node are input into the LLM to obtain an output result of the LLM.

For example, assuming that the second node included in the set of target rules is the rule node, the first prompt information generated based on the target rule represented by the second node and the output result of LLM obtained based on the first node are input into the LLM to obtain the output result of the LLM.

At step S205, until a final output result is obtained, use it as the target text, and the final output result is an output result obtained based on the last node included in the set of target rules.

In the embodiment of the disclosure, the set of target rules includes a plurality of nodes, and the plurality of nodes include a rule node representing a target rule. It can be seen that the embodiment of the disclosure can split the rules that one type of text need to follow into different rule nodes, thereby realizing the decoupling of the rules. In this way, the user can modify, delete or add each rule independently, and can also adjust the sequence of the rules, which improves the flexibility of adjusting the rules that each type of text need to follow.

Moreover, in the case that one type of text needs to follow many rules, if the prompt information is generated directly based on all the rules that the target type of text needs to follow, the generated prompt information may be too long, which exceeds the length limit of input content of the LLM and cannot be input into the LLM.

However, in the embodiment of the disclosure, all the rules that one type of text needs to follow are split into different nodes, and the prompt information can be generated based on some of the rules each time, to avoid the situation that the prompt information exceeds the length limit of input content of the LLM, thereby improving the stability of the text generation process.

In some embodiments of the disclosure, the plurality of nodes included in the set of target rules may also include a parallel node. The parallel node includes a plurality of parallel rule sub-nodes, and each parallel rule sub-node represents a target rule.

For example, a parallel node includes a parallel rule sub-node 1 and a parallel rule sub-node 2, the parallel rule sub-node 1 is “the name of the enterprise is Party A”, and the parallel rule sub-node 2 is “the name of the person is Party B”.

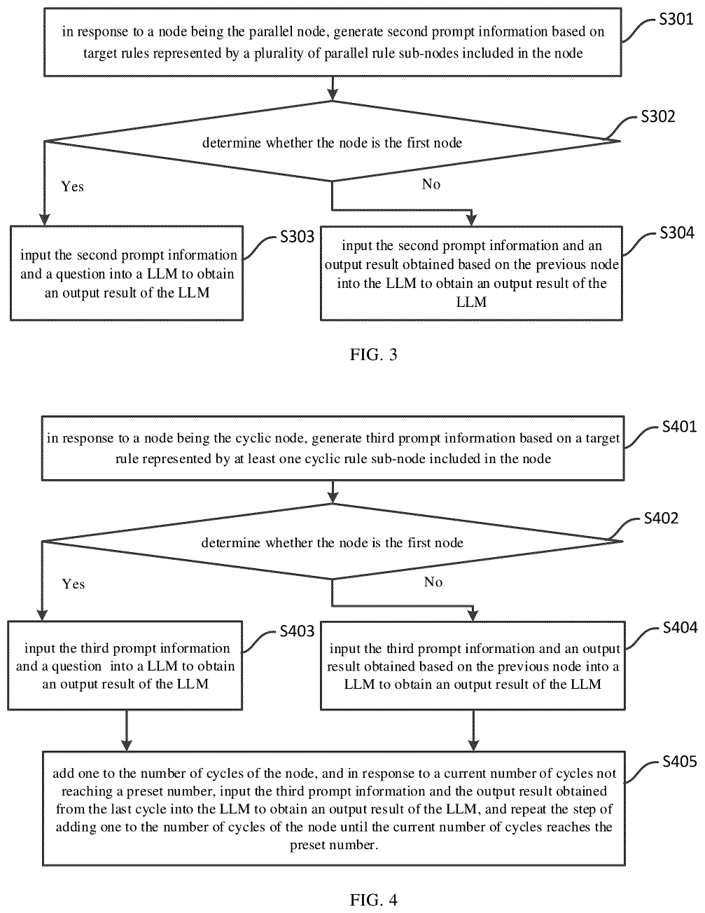

On this basis, as illustrated in FIG. 3, before using a final output as the target text until the final output is obtained in step S205, the electronic device may perform the following steps.

At step S301, in response to a node being a parallel node, second prompt information is generated based on target rules represented by the plurality of parallel rule sub-nodes included in the node.

The way of generating the second prompt information is the same as the way of generating the first prompt information, and can be referred to the related descriptions in step S201 above, which will not be repeated here.

At step S302, it is determined whether the node is the first node, if so, step S303 is performed, if not, step S304 is performed.

At step S303, the second prompt information and the question are input into a LLM to obtain an output result of the LLM.

At step S304, the second prompt information and an output result obtained based on the previous node are input into the LLM to obtain an output result of the LLM.

It can be seen that the embodiment of the disclosure supports setting parallel rules in the parallel node, and one prompt information can be generated based on a plurality of parallel rules included in the one parallel node, so as to reduce the number of times of generating prompt information based on each rule and calling the LLM to generate output results, thereby improving the efficiency of text generation.

In some embodiments of the disclosure, the plurality of nodes included in the set of target rules also include a cyclic node. The cyclic node includes at least one cyclic rule sub-node, and each of cyclic rule sub-nodes represents a target rule.

Understandably, the LLM generate texts that follow different rules with different levels of accuracy. When the LLM generate text following a rule with low accuracy, the LLM may be cyclically generate text that following this rule, so as to improve the possibility of the LLM outputting a text following this rule.

For example, if the accuracy of the LLM generating a text following a target rule 1 is low, the set of target rules include a cyclic node 1, which includes a cyclic rule sub-node 1, and the cyclic rule sub-node 1 represents the target rule 1.

On this basis, as illustrated in FIG. 4, before using a final output as the target text until the final output is obtained in step S205, the electronic device may also perform the following steps.

At step S401, in response to a node being a cyclic node, third prompt information is generated based on a target rule represented by at least one cyclic rule sub-node included in the node.

The way of generating the third prompt information is the same as the way of generating the first prompt information, and can be referred to the related descriptions in step S201 above, which will not be repeated here.

At step S402, it is determined whether the node is the first node, if yes, step S403 is performed, if not, step S404 is performed.

At step S403, in response to the node being the first node, the third prompt information and the question are input into a LLM to obtain an output result of the LLM, and then step S405 is performed.

At step S404, the third prompt information and an output result obtained based on the previous node are input into a LLM to obtain an output result of the LLM, and then step S405 is performed.

It should be noted that if the previous node is a cyclic node, the output result obtained based on the previous node is the output result of the LLM obtained based on the last cycle of the previous node.

At step S405, the number of cycles of the node is added by 1, and in response to a current number of cycles not reaching a preset number, the third prompt information and an output result obtained from the last cycle are input into the LLM to obtain an output result of the LLM, and the step of adding the number of cycles of the node by one is repeated until the current number of cycles reaches the preset number.

In the embodiment of the disclosure, the initial value of the number of cycles of the cyclic node is 0. Each time the electronic device performs S405 for a cyclic node, the number of cycles of the cyclic node is added by 1 until the number of cycles of the cyclic node reaches a preset number, and the final output result of the LLM is taken as the output result obtained based on the cyclic node. After that, the number of cycles of the cyclic node is reset to 0.

Each of cyclic nodes may or may not include a specified number of cycles. When the cyclic node includes a specified number of cycles, the preset number of cycles is the specified number of cycles. When the cyclic node does not include the specified number of cycles, the preset number of cycles is the default number of cycles. For example, the default number of cycles is 3.

Based on the cyclic node, the embodiment of the disclosure can repeatedly call the LLM to generate the text that follows the rule included in the cyclic node, which improves the possibility that the text generated by the LLM follows the rule, thereby improving the accuracy of the text generated by the LLM.

In some embodiments of the disclosure, the plurality of nodes in the set of target rules may include a judgment node. The judgment node includes a judgment condition and at least one judgment rule sub-node, and each of the judgment rule sub-nodes represents a target rule.

It is understood that in practical application scenarios, for the same type of text, the conditions to be followed may be different when the text contains different content.

For example, when the name of Party A in the contract is in English, the rule of capitalizing the first letter of the name of the Party A of the contract needs to be followed, and when the name of Party A in the contract is in Chinese, the rule of capitalizing the first letter of the name of the Party A in the contract does not need to be followed. At this time, the set of target rules may include one judgment node, and the judgment condition included in the judgment node is “whether the name of Party A is all in English”, and the judgment rule sub-node included in the judgment node represents the target rule of “capitalizing the first letter of the name of Party A”.

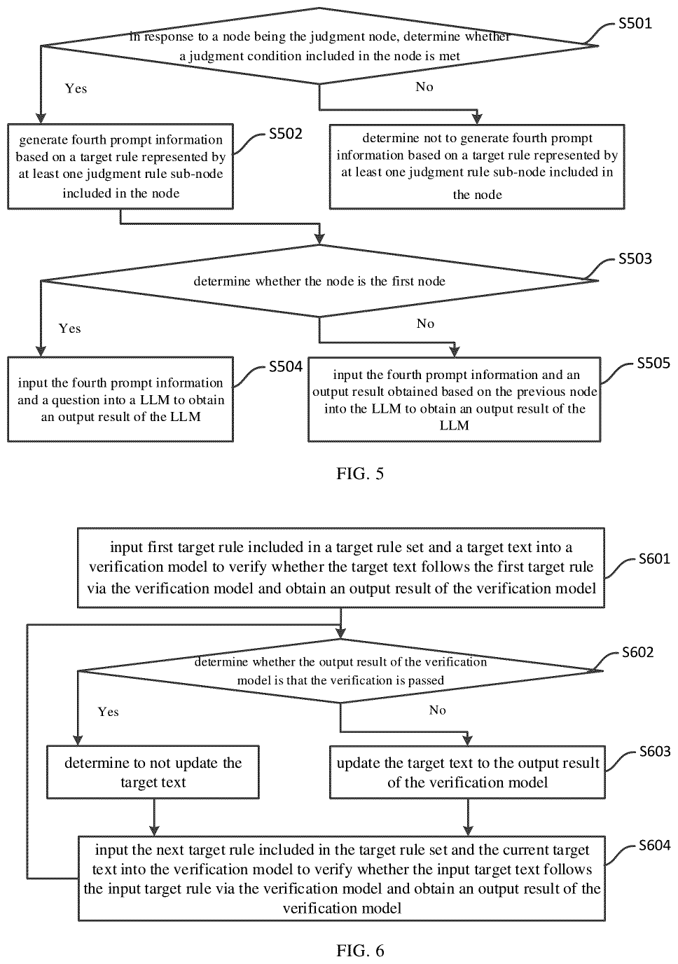

On this basis, as illustrated in FIG. 5, before until the final output result is obtained as the target text in step S205, the electronic device may further perform the following steps.

At step S501, in response to a node being a judgment node, it is determined whether a judgment condition included in the node is met. If yes, step S502 is performed, otherwise, it is determined that the text is not generated based on the target rule represented by the judgment rule sub-node included in the judgment node. That is, the output result obtained based on the previous node of the judgment node is taken as the output result obtained based on the judgment node, and it is skipped to the next node.

The judgment condition included in the judgment node can be set based on the actual application scenario.

At step S502, fourth prompt information is generated based on a target rule represented by at least one judgment rule sub-node included in the node.

The way of generating the fourth prompt information is the same as the way of generating the first prompt information, and can be referred to the related descriptions in step S201 above, which will not be repeated here.

It should be noted that if only one judgment condition is met, the judgment node may include one judgment rule sub-node, and the electronic device may directly generate the fourth prompt information based on the target rule represented by the judgment rule sub-node.

Alternatively, when multiple judgment conditions are met, the judgment node may include a plurality of judgment rule sub-nodes, and each judgment rule sub-node corresponds to one condition that is met. For example, if the judgment condition is “the name of Party A is in Chinese or in English”, two cases exist for this judgment condition. The first case is “the name of Party A is in Chinese”, and the target rule represented by the corresponding judgment rule sub-node is “there are no blank or punctuation in the name of Party A”. The second case is “the name of Party A is in English”, and the target rule represented by the corresponding judgment rule sub-node is “the first letter of the name of Party A is capitalized”. The electronic device can generate the fourth prompt information based on the target rule represented by the judgment rule sub-node corresponding to the case which the judgment condition is met.

At step S503, it is determined whether the node is the first node, if yes, step S504 is perfomed, otherwise, step S505 is performed.

At step S504, the fourth prompt information and the question are input into a LLM to obtain an output result of the LLM.

At step S505, the fourth prompt information and an output result obtained based on the previous node are input into the LLM to obtain an output result of the LLM.

The embodiment of the disclosure can generate the text based on the target rule represented by the judgment rule sub-node included in the judgment node when the judgment condition included in the judgment node is met. If the judgment condition included in the judgment node is not met, the text is not generated based on the target rule, and it is skipped to the next node to continue to generate the text, which improves the flexibility of the target rule in the text generation process, thereby improving the efficiency of generating the text.

In the embodiment of the disclosure, if the number of rules to be followed by a type of text is small, the efficiency of generating text may be reduced by calling the LLM to generate the text strictly according to each rule in turn.

Therefore, before S103, the electronic device can also determine whether the number of rules of the target rules included in the set of target rules is less than a preset number. For example, the preset number is 5.

If the number of rules is less than the preset number, the electronic device generates fifth prompt information based on the plurality of target rules, and then input the fifth prompt information and the question into the LLM to obtain the target text of the target type generated by the LLM.

It should be noted that the plurality of target rules included in the set of target rules are: a target rule represented by a rule nodes, a target rule represented by a parallel rule sub-node included in a parallel node, a target rule represented by a cyclic rule sub-node included in a cyclic node and/or a target rule represented by a judgment rule sub-node included in a judgment node.

The way of generating the fifth prompt information is the same as the way of generating the first prompt information, and can be referred to the related descriptions in step S201 above, which will not be repeated here.

If a number of target rules included in the set of target rules is small, the fifth prompt information generated based on each target rule included in the set of target rules could not be too long and it does not exceed the length limit of input content of the LLM. In this case, the embodiment of the disclosure can directly input the fifth prompt information and the question into the LLM to obtain the target text, which reduces the number of times of calling the LLM, thereby improving the efficiency of generating the target text.

On the other hand, in the embodiment of the disclosure, S103 can be implemented by, in response to the number of rules being greater than or equal to a preset number, inputting sequentially the plurality of target rules into a LLM according to the sequence of the plurality of target rules, to obtain the target text of the target type generated by the LLM.

In this case, the way of generating the target text can be referred to the way of generating the target text in step S103 described above, and the details will not be repeated here.

In the case that the set of target rules includes a large number of target rules, if the prompt information is generated based on each target rule included in the set of target rules, the generated prompt information may be too long, and it may exceed the length limit of input content of the LLM. Therefore, in this case, the embodiment of the disclosure can sequentially call the LLM to generate text according to the sequence of the target rules, thus improving the stability of the text generation process.

In some embodiments of the disclosure, after generating the target text in step S103, in order to improve the accuracy of the text provided to the user, the electronic device also verifies whether the generated target text meets the target rules. The verification method includes the following steps.

At step 1, according to the sequence of the plurality of target rules, it is verified whether the target text follows the target rules.

The electronic device can verify whether the target text follows the target rules according to the sequence of nodes included in the set of target rules for the target rule represented by each node or the target rule represented by sub-nodes included in each node.

At step 2, if the target text follows the plurality of target rules, the target text is showed to the user.

If the target text follows each of the target rules included in the set of target rules, it means that the target text follows all the rules required by the preset type of text, so the target text can be showed to the user.

The electronic device can send the target text to the terminal to show the target text to the user via the terminal. Alternatively, the electronic device can directly show the target text to the user.

By the above method, the embodiment of the disclosure can verify whether the target text follows each of the target rules, and show the target text to the user if the target text follows each of the target rules, which improves the accuracy of the target text provided to the user, thereby improving user experience.

In some embodiments of the disclosure, as illustrated in FIG. 6, the method of verifying whether the target text follows the target rules in Step 1 above includes the following steps.

At step S601, first target rule included in a set of target rules and the target text are input into a verification model to verify whether the target text follows the first target rule via the verification model and obtain an output result of the verification model, in which the output result represents that the verification is passed or a modified text obtained by modifying the input target text according to the input target rule.

The first target rule included in the set of target rules is a target rule represented by the first node included in the set of target rules or a target rule represented by a sub-node of the first node.

The verification model may be a LLM or other NLP models, etc., which is not limited in the embodiment of the disclosure.

At step S602, it is determined whether the output result of the verification model is that the verification is passed, if yes, it is determined to not update the target text and keep the current target text unchanged and step S604 is performed, and if not, step S603 is performed.

At step S603, the target text is updated to the output result of the verification model, and then step S604 is performed.

If the output result of the verification model does not indicate that the verification is passed, it means that the current target text does not follow the target rules after verification, and the verification model modifies the target text and outputs the modified text obtained by modifying the target text according to the input target rules, so the electronic device can update the target text to the output result of the verification model, which improves the accuracy of the target text.

At step S604, the next target rule included in the set of target rules and the current target text are input into the verification model to verify whether the input target text follows the input target rule via the verification model and obtain an output result of the verification model, and then step S602 is returned.

The electronic device may determine the next node of the currently verified node, and take the target rule represented by the next node or the target rule represented by a sub-node of the next node as the next target rule.

It should be noted that if the node is a judgment node, the target rule included in the judgment node may not be verified when the judgment condition of the judgment node is not met. Alternatively, when the judgment condition of the judgment node is met and the judgment node only includes one judgment rule sub-node, the target rule represented by the judgment rule sub-node can be obtained and verified. Alternatively, when the judgment condition of the judgment node is met and the judgment node includes a plurality of judgment rule sub-nodes, the target rule represented by the judgment rule sub-node corresponding to the case where the judgment condition is met can be obtained and verified.

In addition, if the node is a parallel node, the target rules represented by each of parallel rule sub-nodes included in the parallel node are verified separately, or the target rules represented by each of parallel rule sub-nodes included in the parallel node can be verified simultaneously. For example, the target rules represented by the parallel rule sub-nodes of the parallel node are combined, and the combined rules are verified.

The electronic device cyclically performs steps S602-S604 until an output result is obtained based on the last target rule included in the set of target rules. When the output result indicates that the verification is passed, the target text is not updated, and the cycle is completed. Or, when the output result does not indicate that the verification is passed, the target text is updated to this output result, and the cycle is completed.

By the above method, the embodiment of the disclosure can verify whether the target text follows each of the target rules in turn, and continuously update the target text during the verification process, which improves the accuracy of the target text following each target rule.

During the process of verifying whether the target text follows each of the target rules, there is a chance that the verification is not passed. Therefore, after verifying whether the target text follows the target rules in step 1 above, in response to any of the output results obtained based on the plurality of target rules indicating that the verification is not passed, the latest updated target text is showed to the user.

If any of the output results obtained based on the plurality of target rules indicates that the verification is not passed, it means that the initial target text cannot follow all the target rules. In the embodiment of the disclosure, during the verification process, the target text is updated to meet all the target rules. Therefore, in the embodiment of the disclosure, in this case, the latest updated target text is showed to the user, which improves the accuracy of the target text provided to the user, thereby improving the user experience.

It is understood that there may be errors in the verification results of the verification model, and the larger the number of verifications, the smaller the possibility of occurrence of errors in the verification results.

Therefore, in the embodiment of the disclosure, the target rule has a rule level, and the rule level indicates the strictness in verifying the corresponding target rule. For example, the rule levels include: high, medium and low. The high level means that the target text needs to be verified very strictly to satisfy the target rule, the medium level means that the target text needs to be verified strictly to satisfy the target rule, and the low level means that the target text does not need to be verified strictly to satisfy the target rule.

On this basis, the electronic device verifying whether the target text follows the target rules in step 1 above can be implemented by obtaining the number of verifications corresponding to a rule level of a target rule, and verifying whether the target text follows the target rule via the number of verifications. The rule level is positively related to the number of verifications.

The electronic device may look up the number of verifications corresponding to the rule level of the target rule based on the pre-stored preset correspondence between the rule levels and the numbers of verifications.

For example, the preset correspondence between the rule levels and the numbers of verifications is shown in Table 2.

TABLE 2

| Rule level | Number of verifications |
|---|---|
| high | 3 |
| medium | 2 |
| low | 1 |

Assuming that the rule level of a target rule is high, the number of verifications is determined to be 3.

When performing verification for a target rule for many times, each verification process can be referred to steps S601-S603, which is not repeated here.

In the embodiment of the disclosure, the higher the rule level of the target rule, the more times the target rule is validated, which achieves multiple validations of the rule that required strict compliance of the target text, and improves the possibility that the target text follows the rule, i.e., improves the accuracy and compliance of the target text. On the other hand, the lower the rule level of the target rule, the less times the target rule is validated, which reduces the time spent in the verification process and improves the efficiency of displaying the target text to the user.

As illustrated in FIG. 7, the overall flowchart of the method for optimizing content generated by a large model provided by the embodiment of the disclosure is illustrated through an example.

The electronic device receives a question entered by the user sent by the terminal, and then performs text classification for the question to obtain the target type to which a generated text instructed by the question belongs. The electronic device obtains the set of target rules corresponding to the target type based on the correspondence between the plurality of preset sets of rules and the preset types.

As illustrated in FIG. 7, the set of target rules includes a rule node 1, a parallel node 2 and a cyclic node 3. The parallel node 2 includes a parallel rule sub-node 4 and a parallel rule sub-node 5. The cyclic node 3 includes a cyclic rule sub-node 6.

The electronic device generates first prompt information based on a target rule 1 represented by the rule node 1, and inputs the first prompt information and the question into a LLM to obtain an output result of the LLM.

Then, the electronic device generates second prompt information based on a target rule 2 represented by the parallel rule sub-node 4 and a target rule 3 represented by the parallel rule sub-node 5 included in the parallel node 2, and inputs the second prompt information and the output result obtained based on the rule node 1 into the LLM to obtain the output result of the LLM.

Then, the electronic device generates third prompt information based on a target rule 4 represented by the cyclic rule sub-node 6 included in the cyclic node 3, and inputs the third prompt information and the output result obtained based on the parallel node 2 into the LLM to obtain the output result of the LLM. The number of cycles of the cyclic node 3 is added by one, and when the current number of cycles does not reach a preset number, the third prompt information and the output result obtained from the previous cycle are input into the LLM to obtain a output result of the LLM, and the step of adding one to the number of cycles of the cyclic node 3 is repeated until the current number of cycles reaches the preset number. The electronic device takes an output result obtained based on the last cycle of the cyclic node 3 as the target text.

After obtaining the target text, the electronic device inputs the target rule 1 and the target text into a verification model to obtain the output result of the verification model. If the output result does not indicate that the verification is passed, the target text is updated to the output result, and then the target rule 2, the target rule 3 and the current target text are input into the verification model to obtain an output result of the verification model. If the output result does not indicate that the verification is passed, the target text is updated to the output result, and then the target rule 4 and the current target text are input into the verification model to obtain an output result of the verification model. If the output result still does not indicate that the verification is passed, the target text is updated to the output result, and the latest updated target text is showed to the user.

The embodiment of the disclosure constrains the text output by the LLM through the target rules, which improves the possibility that the target text generated based on the LLM comply with the set of target rules. Moreover, after obtaining the target text, whether the target text follows all the target rules can be verified, and the target text is constantly modified, which further ensures the compliance and accuracy of the target text displayed to the user. In this way, the situation that the target text displayed to the user is not in compliance can be avoided, which reduces the chance for the user to modify it repeatedly, i.e., reduces manual intervention, thereby improving the generation efficiency of the target text. The embodiment of the disclosure can be applied to fields or products that need to comply with standards or regulations, such as official document processing, automatic contract generation, legal document writing and enterprise internal system management.

In the technical schemes of the disclosure, collection, storage, use, processing, transmission, provision and disclosure of the problems and rules involved are in compliance with the provisions of relevant laws and regulations, and do not violate public order and good customs.

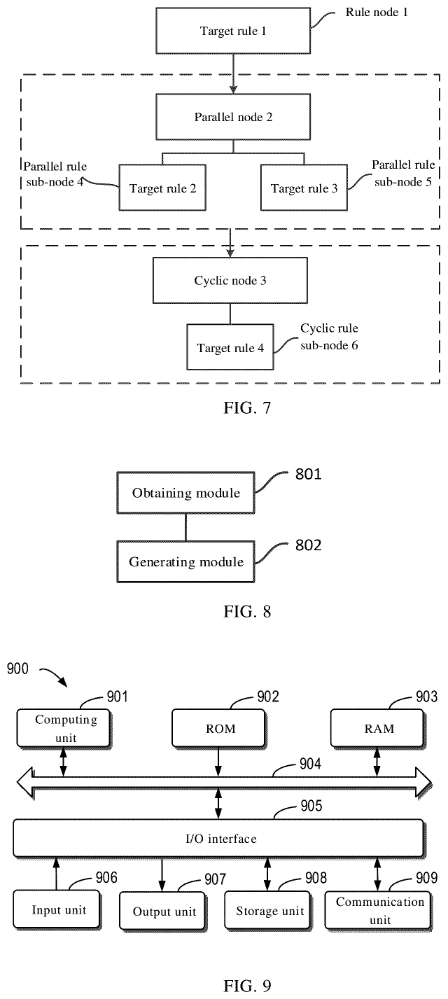

Based on the same inventive concept, corresponding to the above method embodiments, the embodiment of the disclosure also provides an apparatus for optimizing content generated by a large model. As illustrated in FIG. 8, the apparatus includes an obtaining module 801 and a generating module 802.

The obtaining module 801 is configured to obtain a question entered by a user, in which the question is used to instruct the generation of a text of target type.

The obtaining module 801 is further configured to obtain a set of target rules corresponding to the target type from a plurality of preset sets of rules, in which the set of target rules includes a plurality of target rules, and the target rules are rules followed by the text of target type.

The generating module 802 is configured to, according to a sequence of the target rules, input sequentially the target rules into a LLM to obtain a target text of the target type generated by the LLM.

In some embodiments of the disclosure, the set of target rules includes a plurality of nodes connected in series, and the plurality of nodes include a rule node representing the target rule, and the generating module 802 is configured to:
according to a sequence of the nodes, in response to a node being a rule node, generate first prompt information based on a target rule represented by the node;
in response to the node being the first node included in the set of target rules, input the first prompt information and the question into the LLM to obtain an output result of the LLM; or
in response to the node not being the first node, input the first prompt information and an output result obtained based on the previous node into the LLM to obtain an output result of the LLM; and
use a final output as the target text until the final output is obtained, which is based on the last node included in the set of target rules.

In some embodiments of the disclosure, the plurality of nodes further include a parallel node, the parallel nodes include a plurality of parallel rule sub-nodes, and the parallel rule sub-nodes represent one of the target rules, and the generating module 802 is configured to:
before using a final output as the target text until the final output is obtained, in response to a node being a parallel node, generate second prompt information based on a target rule represented by a plurality of parallel rule sub-nodes included in the node;
in response to the node being the first node, input the second prompt information and the question into the LLM to obtain an output result of the LLM; or
in response to the node not being the first node, input the second prompt information and an output result obtained based on the previous node into the LLM to obtain an output result of the LLM.

In some embodiments of the disclosure, the plurality of nodes also include a cyclic node, the cyclic node includes at least one cyclic rule sub-node, and the at least one cyclic rule sub-node represents one of the target rules, and the generating module 802 is configured to:
before using a final output as the target text until the final output is obtained, in response to a node being a cyclic node, generate third prompt information based on a target rule represented by at least one cyclic rule sub-node included in the node;
in response to the node being the first node, input the third prompt information and the question into the LLM to obtain an output result of the LLM; or
in response to the node not being the first node, input the third prompt information and an output result obtained based on the previous node into the LLM to obtain an output result of the LLM; and
add one to the number of cycles of the node, and in response to a current number of cycles not reaching a preset number, input the third prompt information and an output result obtained from the last cycle into the LLM to obtain an output result of the LLM, and return to the step of adding one to the number of cycles of the node until the current number of cycles reaches the preset number.

In some embodiments of the disclosure, the plurality of nodes further include a judgment node, the judgment node includes a judgment condition and at least one judgment rule sub-node, and the at least one judgment rule sub-node represents one of the target rules, and the generating module 802 is configured to:
before using a final output as the target text until the final output is obtained, in response to a node being a judgment node, determine whether a judgment condition included in the node is met;
if yes, generate fourth prompt information based on a target rule represented by at least one judgment rule sub-node included in the node;
in response to the node being the first node, input the fourth prompt information and the question into the LLM to obtain an output result of the LLM; or
in response to the node not being the first node, input the fourth prompt information and an output result obtained based on the previous node into the LLM to obtain an output result of the LLM.

In some embodiments of the disclosure, the generating module 802 is configured to:
in response to a number of target rules included in the set of target rules being greater than or equal to a preset number, input the target rules into the LLM sequentially according to the sequence of the target rules to obtain the target text of the target type generated by the LLM.

In some embodiments of the disclosure, the generating module 802 is configured to:
in response to the number of target rules being less than the preset number, generate fifth prompt information based on the plurality of target rules; and
input the fifth prompt information and the question into the LLM to obtain the target text of the target type generated by the LLM.

In some embodiments of the disclosure, the apparatus further includes:
a verification module, configured to, after inputting the target rules into the LLM sequentially according to the sequence of the target rules to obtain the target text of the target type generated by the LLM, verify whether the target text follows the target rules according to the sequence of the target rules; and
a display module, configured to, in response to the target text following the plurality of target rules, display the target text to the user.

In some embodiments of the disclosure, the verification module is configured to:
input first target rule included in the set of target rules and the target text into a verification model to verify whether the target text follows the first target rule via the verification model and obtain an output result of the verification model, in which the output result represents the output result represents that the verification is passed or a modified text obtained by modifying the input target text according to the input target rule;
determine whether the output result of the verification model is that the verification is passed;
if not, update the target text to the output result of the verification model; and
input the next target rule included in the set of target rules and the current target text into the verification model to verify whether the input target text follows the input target rule via the verification model and obtain an output result of the verification model, and return to the step of determining whether the output result of the verification model is that the verification is passed.

In some embodiments of the disclosure, the display module is further configured to:
after verifying whether the target text follows the target rules according to the sequence of the target rules, in response to any of the output results obtained based on the plurality of target rules does not indicate that the verification has passed, display the latest updated target text to the user.

In some embodiments of the disclosure, the target rule has a rule level, and the verification module is configured to:
obtain a number of verifications corresponding to a rule level of a target rule, in which the rule level is positively related to the number of verifications; and
verify whether the target text follows the target rule via the number of verifications.

In some embodiments of the disclosure, the obtaining module 801 is further configured to:
determine a set of rules selected by the user from the plurality of preset sets of rules as the set of target rules; or,
perform text classification on the question to obtain a target type to which a generated text indicated by the question belongs; and
obtain a set of target rules corresponding to the target type based on a correspondence between the plurality of preset sets of rules and preset types.

According to the embodiment of the disclosure, the disclosure also provides an electronic device, a readable storage medium, and a computer program product.

FIG. 9 is a schematic diagram of an exemplary electronic device 900 used to implement the embodiment of the disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile devices, such as personal digital processors, cellular phones, smart phones, wearable devices, and other similar computing devices. The components shown here, their connections and relations, and their functions are merely examples, and are not intended to limit the implementation of the disclosure described and/or required herein.

As illustrated in FIG. 9, the electronic device 900 includes a computing unit 901 for performing various appropriate actions and processes based on computer programs stored in a Read-Only Memory (ROM) 902 or computer programs loaded from a storage unit 908 to a Random Access Memory (RAM) 903. In the RAM 903, various programs and data required for the operation of the electronic device 900 are stored. The computing unit 901, the ROM 902, and the RAM 903 are connected to each other through a bus 904. An input/output (I/O) interface 905 is also connected to the bus 904.

Components in the electronic device 900 are connected to the I/O interface 905, including: an input unit 906, such as a keyboard, a mouse; an output unit 907, such as various types of displays, speakers; a storage unit 908, such as a disk, an optical disk; and a communication unit 909, such as network cards, modems, and wireless communication transceivers. The communication unit 909 allows the electronic device 900 to exchange information/data with other devices through a computer network such as the Internet and/or various telecommunication networks.

The computing unit 901 may be various general-purpose and/or dedicated processing components with processing and computing capabilities. Some examples of the computing unit 901 include, but are not limited to, a Central Processing Unit (CPU), a Graphics Processing Unit (GPU), various dedicated AI computing chips, various computing units that run machine learning (ML) model algorithms, a Digital Signal Processor (DSP), and any appropriate processor, controller and microcontroller. The computing unit 901 executes the various methods and processes described above, such as the method for optimizing content generated by a large model. For example, in some embodiments, the method for optimizing content generated by a large model may be implemented as a computer software program, which is tangibly contained in a machine-readable medium, such as the storage unit 908. In some embodiments, part or all of the computer programs may be loaded and/or installed on the electronic device 900 via the ROM 902 and/or the communication unit 909. When the computer program is loaded on the RAM 903 and executed by the computing unit 901, one or more steps of the method for optimizing content generated by a large model described above may be executed. Alternatively, in other embodiments, the computing unit 901 may be configured to perform the method for optimizing content generated by a large model in any other suitable manner (for example, by means of firmware).

Various implementations of the systems and techniques described above may be implemented by a digital electronic circuit system, an integrated circuit system, a Field Programmable Gate Array (FPGA), an Application Specific Integrated Circuit (ASIC), an Application Specific Standard Product (ASSP), a System on Chip (SOC), a Complex Programmable Logic Device (CPLD), a computer hardware, a firmware, a software, and/or a combination thereof. These various implementations may be implemented in one or more computer programs, the one or more computer programs may be executed and/or interpreted on a programmable system including at least one programmable processor, which may be a dedicated or general programmable processor for receiving data and instructions from a storage system, at least one input device and at least one output device, and transmitting the data and instructions to the storage system, the at least one input device and the at least one output device.

The program code configured to implement the method of the disclosure may be written in any combination of one or more programming languages. These program codes may be provided to the processors or controllers of general-purpose computers, dedicated computers, or other programmable data processing devices, so that the program codes, when executed by the processors or controllers, enable the functions/operations specified in the flowchart and/or block diagram to be implemented. The program code may be executed entirely on the machine, partly executed on the machine, partly executed on the machine and partly executed on the remote machine as an independent software package, or entirely executed on the remote machine or server.

In the context of the disclosure, a machine-readable medium may be a tangible medium that may contain or store a program for use by or in combination with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of machine-readable storage medium include electrical connections based on one or more wires, portable computer disks, hard disks, RAMs, ROMs, Electrically Programmable Read-Only-Memories (EPROM), flash memories, fiber optics, Compact Disc Read-Only Memories (CD-ROM), optical storage devices, magnetic storage devices, or any suitable combination of the foregoing.

In order to provide interaction with a user, the systems and techniques described herein may be implemented on a computer having a display device (e.g., a Cathode Ray Tube (CRT) or a Liquid Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (e.g., a communication network). Examples of communication networks include: Local Area Network (LAN), Wide Area Network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host. The server may be a cloud server, a distributed system server, or a server combined with a blockchain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific implementations do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

What is claimed is:

1. A method for optimizing content generated by a large model, comprising:
obtaining a question entered by a user, wherein the question is used to instruct a generation of a text of a target type;
obtaining, from a plurality of preset sets of rules, a set of target rules corresponding to the target type, wherein the set of target rules comprises a plurality of target rules, and the target rules are rules to be followed by the text of the target type; and
inputting the plurality of target rules sequentially into a large language model according to a sequence of the plurality of target rules to obtain a target text of the target type generated by the large language model.

2. The method of claim 1, wherein the set of target rules comprises a plurality of nodes connected in series, and the plurality of nodes comprise a rule node representing one of the target rules, and inputting the plurality of target rules sequentially into the large language model according to the sequence of the plurality of target rules to obtain the target text of the target type generated by the large language model, comprises:
according to a sequence of the plurality of nodes, performing the following steps for each node:
in response to the node being the rule node, generating first prompt information based on a target rule represented by the node;
in response to the node being the first node included in the set of target rules, inputting the first prompt information and the question into the large language model to obtain an output result of the large language model;
in response to the node not being the first node, inputting the first prompt information and an output result obtained based on a previous node into the large language model to obtain an output result of the large language model; and
determining a final output result as the target text, wherein the final output result is an output result obtained based on the last node included in the set of target rules.

3. The method of claim 2, wherein the plurality of nodes further comprise a parallel node, the parallel node comprises a plurality of parallel rule sub-nodes, and each of the parallel rule sub-nodes represents one of the target rules, and before determining the final output result as the target text, the method further comprises:
in response to a node being the parallel node, generating second prompt information based on target rules represented by a plurality of parallel rule sub-nodes included in the node;
in response to the node being the first node, inputting the second prompt information and the question into the large language model to obtain an output result of the large language model;
in response to the node not being the first node, inputting the second prompt information and an output result obtained based on the previous node into the large language model to obtain an output result of the large language model.

4. The method of claim 2, wherein the plurality of nodes also comprise a cyclic node, the cyclic node comprises at least one cyclic rule sub-node, and the at least one cyclic rule sub-node represents one of the target rules, and before determining the final output result as the target text, the method further comprises:
in response to a node being the cyclic node, generating third prompt information based on a target rule represented by at least one cyclic rule sub-node included in the node;
in response to the node being the first node, inputting the third prompt information and the question into the large language model to obtain an output result of the large language model;
in response to the node not being the first node, inputting the third prompt information and an output result obtained based on the previous node into the large language model to obtain an output result of the large language model; and
adding one to the number of cycles of the node, and in response to a current number of cycles not reaching a preset number, inputting the third prompt information and an output result obtained from a previous cycle into the large language model to obtain an output result of the large language model, and repeating the steps of adding one to the number of cycles of the node and inputting the third prompt information and the output result obtained from the previous cycle, until the current number of cycles reaches the preset number.

5. The method of claim 2, wherein the plurality of nodes further comprise a judgment node, the judgment node comprises a judgment condition and at least one judgment rule sub-node, and the judgment rule sub-node represents one of the target rules, and before determining the final output result as the target text, the method further comprises:
in response to a node being the judgment node, determining whether a judgment condition included in the node is met;
if yes, generating fourth prompt information based on a target rule represented by a judgment rule sub-node included in the node;
in response to the node being the first node, inputting the fourth prompt information and the question into the large language model to obtain an output result of the large language model;
in response to the node not being the first node, inputting the fourth prompt information and an output result obtained based on the previous node into the large language model to obtain an output result of the large language model.

6. The method of claim 1, wherein the step of inputting the plurality of target rules sequentially into the large language model according to the sequence of the plurality of target rules to obtain the target text of the target type generated by the large language model, comprises:
in response to the number of the plurality of target rules included in the set of target rules being greater than or equal to a preset number, inputting the plurality of target rules into the large language model sequentially according to the sequence of the plurality of target rules to obtain the target text of the target type generated by the large language model.

7. The method of claim 6, further comprising:
in response to the number of the plurality of target rules being less than the preset number, generating fifth prompt information based on the plurality of target rules; and
inputting the fifth prompt information and the question into the large language model to obtain the target text of the target type generated by the large language model.

8. The method of claim 1, wherein inputting the plurality of target rules sequentially into the large language model according to the sequence of the plurality of target rules to obtain the target text of the target type generated by the large language model, comprises:
verifying whether the target text follows the plurality of target rules according to the sequence of the plurality of target rules; and
in response to the target text following the plurality of target rules, displaying the target text to a user.

9. The method of claim 8, wherein verifying whether the target text follows the plurality of target rules according to the sequence of the plurality of target rules, comprises:
according to the sequence of the plurality of target rules, performing the following steps for each target rule in the set of target rules:
inputting the target rule included and the target text into a verification model to verify whether the target text follows the target rule via the verification model and obtain an output result of the verification model, wherein the output result of the verification model represents that the verification is passed or a modified text obtained by modifying the target text according to the target rule;
determining whether the output result of the verification model indicates that the verification is passed; and
if not, updating the target text to the output result of the verification model.

10. The method of claim 9, wherein after verifying whether the target text follows the plurality of target rules according to the sequence of the plurality of target rules, comprises:
in response to any of the output results obtained based on the plurality of target rules not indicating that the verification is passed, displaying the latest updated target text to the user.

11. The method of claim 8, wherein the target rule has a rule level, and verifying whether the target text follows the plurality of target rules, comprises:
obtaining the number of verifications corresponding to a rule level of a target rule, wherein the rule level is positively related to the number of verifications; and
verifying whether the target text follows the target rule via the number of verifications.

12. The method of claim 1, wherein obtaining the set of target rules corresponding to the target type from the plurality of preset sets of rules, comprises:
determining a set of rules selected by a user from the plurality of preset sets of rules as the set of target rules; or,
performing text classification on the question to obtain a target type to which a generated text instructed by the question belongs; and obtaining the set of target rules corresponding to the target type based on a correspondence between the plurality of preset sets of rules and preset types.

13. An electronic device, comprising:
at least one processor; and
a memory communicatively connected to the at least one processor;
wherein the processor is configured to:
obtain a question entered by a user, wherein the question is used to instruct a generation of a text of a target type;
obtain, from a plurality of preset sets of rules, a set of target rules corresponding to the target type, wherein the set of target rules comprises a plurality of target rules, and the target rules are rules to be followed by the text of the target type; and
input the plurality of target rules sequentially into a large language model according to a sequence of the plurality of target rules to obtain a target text of the target type generated by the large language model.

14. The electronic device of claim 13, wherein the set of target rules comprises a plurality of nodes connected in series, and the plurality of nodes comprise a rule node representing one of the target rules, and input the plurality of target rules sequentially into the large language model according to the sequence of the plurality of target rules to obtain the target text of the target type generated by the large language model, comprises:
according to a sequence of the plurality of nodes, perform the following steps for each node:
in response to the node being the rule node, generate first prompt information based on a target rule represented by the node;
in response to the node being the first node included in the set of target rules, input the first prompt information and the question into the large language model to obtain an output result of the large language model;
in response to the node not being the first node, input the first prompt information and an output result obtained based on the previous node into the large language model to obtain an output result of the large language model; and
determine a final output result as the target text, wherein the final output result is an output result obtained based on the last node included in the set of target rules.

15. The electronic device of claim 14, wherein the plurality of nodes further comprise a parallel node, the parallel nodes comprise a plurality of parallel rule sub-nodes, and each of the parallel rule sub-nodes represents one of the target rules, and before determining the final output result as the target text, further comprises:
in response to a node being the parallel node, generate second prompt information based on target rules represented by the plurality of parallel rule sub-nodes included in the node;
in response to the node being the first node, input the second prompt information and the question into the large language model to obtain an output result of the large language model;
in response to the node not being the first node, input the second prompt information and an output result obtained based on the previous node into the large language model to obtain an output result of the large language model.

16. The electronic device of claim 14, wherein the plurality of nodes also comprise a cyclic node, the cyclic node comprises at least one cyclic rule sub-node, and each of the at least one cyclic rule sub-nodes represents one of the target rules, and before determining the final output result as the target text, further comprises:
in response to a node being the cyclic node, generate third prompt information based on a target rule represented by at least one cyclic rule sub-node included in the node;
in response to the node being the first node, input the third prompt information and the question into the large language model to obtain an output result of the large language model;
in response to the node not being the first node, input the third prompt information and an output result obtained based on the previous node into the large language model to obtain an output result of the large language model; and
add one to the number of cycles of the node, and in response to a current number of cycles not reaching a preset number, input the third prompt information and an output result obtained from the last cycle into the large language model to obtain an output result of the large language model, and repeating the steps of adding one to the number of cycles of the node and inputting the third prompt information and the output result obtained from the previous cycle.

17. The electronic device of claim 14, wherein the plurality of nodes further comprise a judgment node, the judgment node comprises a judgment condition and at least one judgment rule sub-node, and the judgment rule sub-node represents one of the target rules, and before determining the final output result as the target text, further comprises:
in response to a node being the judgment node, determine whether a judgment condition included in the node is met;
if yes, generate fourth prompt information based on a target rule represented by the judgment rule sub-node included in the node;
in response to the node being the first node, input the fourth prompt information and the question into the large language model to obtain an output result of the large language model;
in response to the node not being the first node, input the fourth prompt information and an output result obtained based on the previous node into the large language model to obtain an output result of the large language model.

18. The electronic device of claim 13, wherein input the target rules into the large language model sequentially according to the sequence of the target rules to obtain the target text of the target type generated by the large language model, comprises:
verify whether the target text follows the target rules according to the sequence of the target rules; and
in response to the target text following the plurality of target rules, display the target text to the user.

19. A non-transitory computer-readable storage medium having computer instructions stored thereon, wherein the computer instructions are used to cause a computer to implement the method for optimizing content generated by a large model, comprising:
obtaining a question entered by a user, wherein the question is used to instruct a generation of a text of a target type;
obtaining, from a plurality of preset sets of rules, a set of target rules corresponding to the target type, wherein the set of target rules comprises a plurality of target rules, and the target rules are rules to be followed by the text of the target type; and
inputting the plurality of target rules sequentially into a large language model according to a sequence of the plurality of target rules to obtain a target text of the target type generated by the large language model.

20. A computer program product comprising a computer program, wherein when the computer program is executed by a processor, the method of claim 1 is implemented.
